(19) United States
(12) Patent Application Publication
(10) Pub. No.: US 2008/0151126 A1
(43) Pub. Date: Jun. 26, 2008

(54) Remote control having audio-visual function

(75) Inventor: Wen-Ping Yu, Chung Ho City (TW)

Correspondence Address: BIRCH STEWART KOLASCH & BIRCH, PO BOX 747, FALLS CHURCH, VA, 22040-0747, US

(73) Assignee: AmTRAN TECHNOLOGY CO., LTD.

(21) Appl. No.: 11/727,131

(22) Filed: Mar. 23, 2007

(30) Foreign Application Priority Data
Dec. 20, 2006 (TW) 095222462

(51) Int. Cl. G09G 3/36; G06F 3/041; H04N 5/44

(52) U.S. Cl. 348/734; 345/173; 345/87; 348/E05.103

(57) ABSTRACT

A remote control device having a tracking unit is provided. The remote control device has an audio code receiver therein and cooperated with a transmitter. When the device being used by a user, the transmitter generates an audio signal to the corresponding audio code receiver in the remote control device, so that the remote control device will generate a sound; therefore, the user can easy find the remote control device. The transmitter includes a sound signal generating unit, a sound processor, a control interface, and a speaker. The audio code receiver includes a sound controller, a signal frequency and timing detector, a received signal processor, and a sound sensor and a sound generating unit, and so on. By way of using the remote control device which includes several difference audio code receivers, the user can easily find the remote control device.

### CROSS-REFERENCE TO RELATED APPLICATIONS

This non-provisional application claims priority under 35 U.S.C. § 119(a) on Patent Application No(s). 095222462 filed in Taiwan, R.O.C. on Dec. 20, 2006, the entire contents of which are hereby incorporated by reference.

### BACKGROUND OF THE INVENTION

1. Field of the Invention

The present invention relates to a remote control, and more particularly to a remote control having an audio-visual function.

2. Related Art

Currently, various electronic products are widely available in the market, and in order to meet the consumers' requirements, those with a single function have no longer been the mainstream of the public consumer products, and thus, those electronic products integrated with multiple functions has the merit of one machine with multi-use functions, which eliminates the trouble in portability, and further enhances the application efficiency of the electronic products, and thus becoming a developing trend of the consumer electronic products in the era of science and technology.

The remote control technology has been widely applied in various electronic products, in which the wireless signal transmission is utilized to enable the user to remotely control the electronic products. However, in order to attract the consumers' attention, the remote control with multiple additional functions has become the researching and development direction for persons in this field. As disclosed in Taiwan Patent Publication No. 00587876, entitled “Remote Control having Display Screen”, a synchronous viewing function is further added on a conventional remote control, and thus the remote control and the television (TV) set can play pictures synchronously through a wired connection between an AV transmission line and the TV terminal.

### SUMMARY OF THE INVENTION

Although a remote control having an additional viewing function has been provided in the prior art, it is only achieved through the wired connection, and thus, the distance for the user to take along the remote control is greatly restricted, and the remote control merely having the additional viewing function also cannot meet the user's requirements. Therefore, the present invention provides a remote control having an audio-visual function, which can perform a high-frequency wireless transmission of audio-visual data with a remote TV set.

The remote control having the audio-visual function of the present invention includes a wireless signal processing unit, a central processing unit (CPU), a display unit, and an input interface unit.

The wireless signal processing unit is used for sending and receiving an audio-visual signal, and encoding/decoding and demodulating/modulating the audio-visual signal. The CPU is connected to the wireless signal processing unit, for performing the calculation process to the audio-visual signal. The display unit is connected to the CPU for displaying pictures of the image signal. The input interface unit is connected to the wireless signal processing unit and the display unit, and the input interface is provided for the user to input a control signal to control each audio-visual transmission function. Moreover, the wireless signal processing unit further includes an infrared module and an RF module. The infrared module has an infrared transmitter for transmitting a control signal to operate the remote TV set. The radio frequencies (RF) module is used for performing the wireless transmission of the audio-visual signal, and includes an RF transmitter, a RF receiver, a modem, and an encoder/decoder. The RF transmitter is used for transmitting the audio-visual signal in an RF way. The RF receiver is used for receiving the audio-visual signal in an RF way. The modem is connected to the RF transmitter and the RF receiver for demodulating/modulating the audio-visual signal. The encoder/decoder is connected to the modem for encoding/decoding the audio-visual signal.

The remote control having an audio-visual function of the present invention further includes an image-capturing unit and a sound source input/output unit. The image-capturing unit is connected to the CPU for capturing an external image signal, providing a video signal transmission function, and serving as a complementary media for finding a remote control. The sound source input/output unit is connected to the CPU for receiving an external sound and outputting a sound signal. Moreover, the image-capturing unit has a circuit board, a lens, and a photosensor. The circuit board has a control circuit for controlling the transmission of an electrical signal. The lens is disposed on the circuit board, and has a filter and a plurality of optical lenses, for collecting external images. The photosensor is disposed on the circuit board for converting the captured external images into image signals. Furthermore, the sound source input/output unit further includes a loudspeaker and a microphone. The loudspeaker is used for outputting the sound signal calculated by the CPU, and the microphone is used for receiving the external sound, and converting it into a sound signal for being transferred to the CPU.

The remote control having the audio-visual function of the present invention can meet the users' requirements on the additional function of the remote control, and particularly, the remote control of the present invention not only can achieve the function of synchronous viewing with the remote TV set as that disclosed in the prior art, but also achieve the effect that different programs can be viewed at the same time. Moreover, the present invention transmits the audio-visual data in a wireless transmission way, which is not limited by the wired transmission in the prior art and convenient for the user to take along. Furthermore, the present invention is further integrated with the video conversation function, which provides the user with the video conversation function between the user and the remote TV set, thereby expanding the additional function of the remote control, so as to meet the users' requirements.

The features and examples of the advantageous embodiments of the present invention are illustrated in detail with reference to the drawings below.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic block diagram of a remote control having an audio-visual function according to a first embodiment of the present invention;

FIG. 2 is a schematic structural view of a wireless signal processing unit of the remote control having the audio-visual function of the present invention;

FIGS. 3A and 3B show an implementation aspect of the remote control having the audio-visual function of the present invention;

FIG. 4 is a schematic block diagram of a remote control having an audio-visual function according to a second embodiment of the present invention;

FIG. 5 is a schematic structural view of an image-capturing unit of the remote control having the audio-visual function of the present invention; and

FIG. 6 shows another implementation aspect of the remote control having the audio-visual function of the present invention.

### DETAILED DESCRIPTION OF THE INVENTION

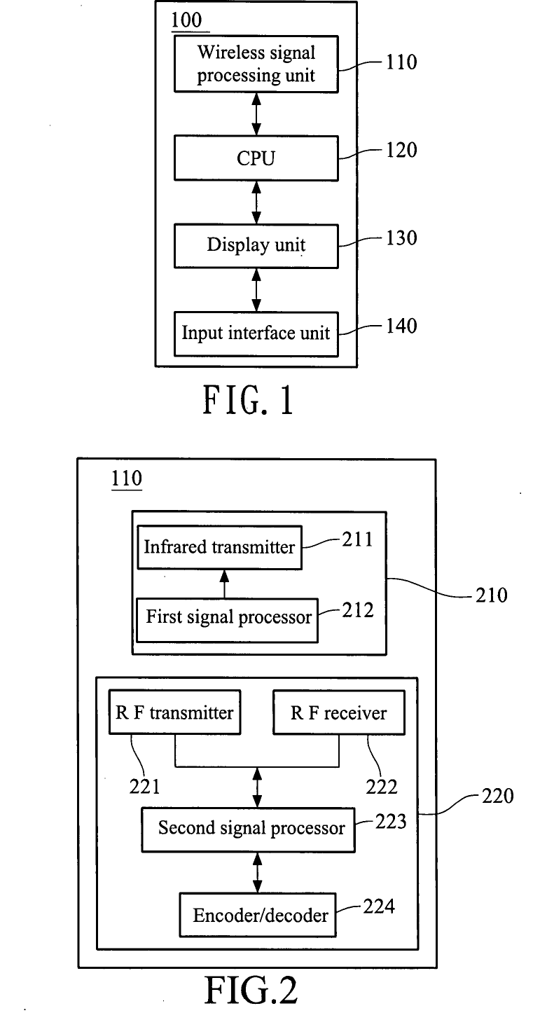

FIG. 1 is a schematic block diagram of a remote control having an audio-visual function of the present invention. The remote control 100 having an audio-visual function of the present invention includes a wireless signal processing unit 110, a central processing unit (CPU) 120, a display unit 130, and an input interface unit 140.

The wireless signal processing unit 110 is used for receiving and sending an audio-visual signal, the signal receiving mechanism thereof is to demodulate the received analog audio-visual signal into a digital audio-visual signal and decodes the digital audio-visual signal, and the signal sending mechanism thereof is to encode the digital audio-visual signal and then modulates it into an analog audio-visual signal for being wirelessly transmitted. The CPU 120 is connected to the wireless signal processing unit 110 for performing the calculation, compensation, and modification operations to the digital audio-visual signal. The display unit 130 is connected to the CPU 120 for outputting pictures of the image produced by the calculation process of the CPU 120 for being viewed by the user. For example, the display unit 130 may be a liquid crystal display (LCD) or an organic light emitting diode (OLED). The input interface unit 140 is connected to the CPU 120 and the display unit 130, and the input interface unit 140 is provided for the user to input a control signal, such as the operation instructions including powering on, channel selection, image quality adjustment, function switch (AV/TV), screen switch (picture in picture (PIP)), and volume adjustment, so as to control each audio-visual transmission function. For example, the input interface unit 140 is a key module or a touch panel for inputting control instructions through the display unit 130.

Referring to FIG. 2, the wireless signal processing unit 110 further includes an infrared module 210 and an RF module 220. The infrared module 210 has an infrared transmitter 211 and a first signal processor 212, and the infrared transmitter 211 is connected to the first signal processor 212. The control instruction inputted by the input interface unit 140 is converted into a control signal through the first signal processor 212, and then, the control signal is sent through the infrared transmitter 211 for operating a remote TV set. The RF module 220 is used for executing a wireless transmission of the audio-visual signal, and includes an RF transmitter 221, an RF receiver 222, a second signal processor 223, and an encoder/decoder 224. The RF transmitter 221 sends the audio-visual signal in an RF way, and the RF receiver 222 receives the audio-visual signal transmitted from the remote transmitter. The second signal processor 223 is connected to the RF transmitter 221 and the RF receiver 222 for demodulating/modulating the audio-visual signal, and the encoder/decoder 224 is connected to the second signal processor 223 for encoding/decoding the audio-visual signal.

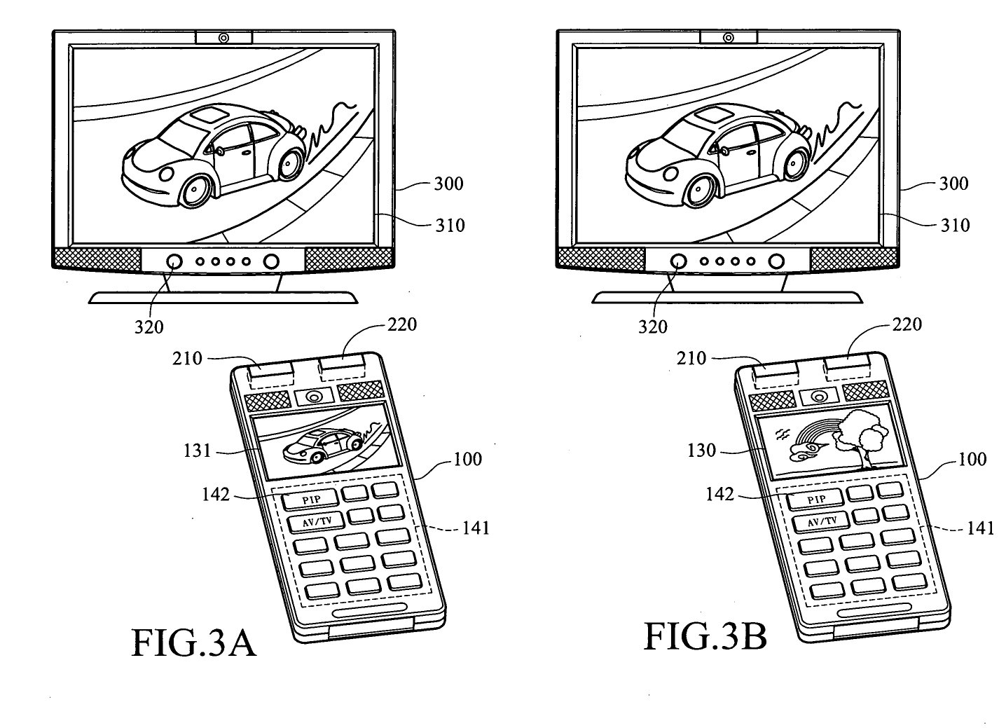

The implementation aspects of the remote control having an audio-visual function of the present invention are illustrated below in detail with reference to FIGS. 3A and 3B.

FIGS. 3A and 3B show an implementation aspect of the remote control having the audio-visual function of the present invention. First of all, the user presses the PIP switch key 142 on the remote control 100, so as to select to control the displayed picture 310 on the remote TV set 300 or the displayed picture 131 on the remote control 100. If the user selects a parent picture function, he/she can input and select a channel through the key module 141 on the remote control 100, and then, the control signal is sent to the infrared receiver 320 on the remote TV set 300 through the infrared module 210, so as to achieve the channel selection function of a common remote control. On the other aspect, if the user selects the child picture function by pressing the PIP switch key 142, he/she can input and select a channel through the key module 141 on the remote control 100, thereby adjusting the receiving frequency of the RF module 220 to directly receive the audio-visual signal transferred from a remote base station. Therefore, as shown in FIG. 3A, the remote control 100 of the present invention enables the user to view the same program content as that on the remote TV set 300, so as to solve the problem that the user cannot sit in front of the TV set due to some reasons and miss some excellent shots. Moreover, as shown in FIG. 3B, the user also can select to view other program content different from that played on the remote TV set 300 through the child picture on the remote control 100 of the present invention, which provides multiple diversified choices for the user. Furthermore, the remote control is convenient for being taken along, which solves the troubles in portability, and thus the remote control of the present invention can be considered as a mobile TV set.

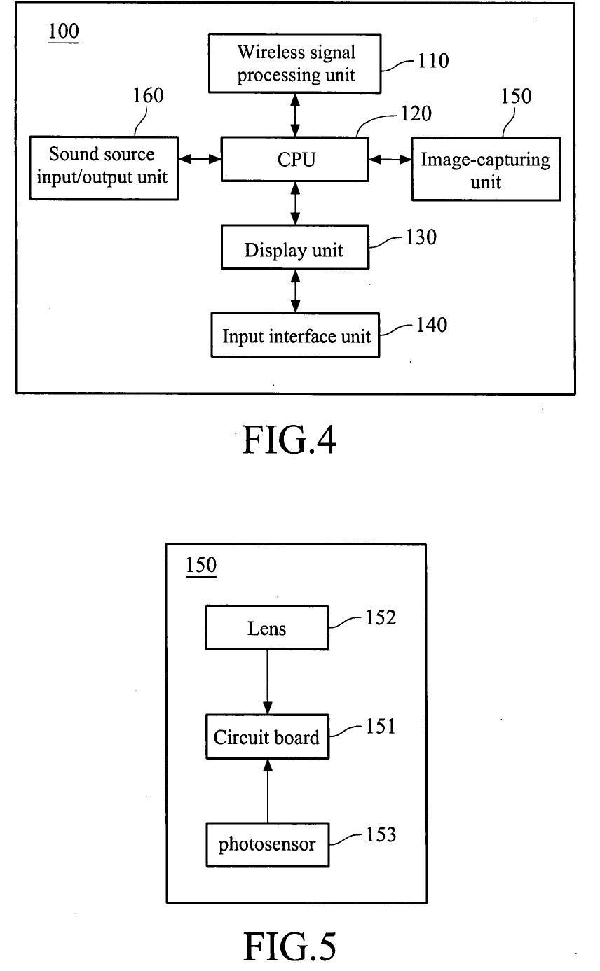

Moreover, as shown in FIG. 4, the remote control 100 of the present invention further includes an image-capturing unit 150 and a sound source input/output unit 160.

The image-capturing unit 150 is connected to the CPU 120, and external images are captured through the image-capturing unit 150. As shown in FIG. 5, the image-capturing unit 150 includes a circuit board 151, a lens 152, and a photosensor 153. A control circuit is disposed on the circuit board 151 for controlling the transference of an electrical signal. The lens 152 is disposed on the circuit board 151 and includes a filter and a plurality of optical lenses, for focusing an optical signal of the external image. The photosensor 153 is connected to the control circuit on the circuit board 151, and the lens 152 is used to focus the optical signal onto the photosensor 163, and then, the optical signal is converted by the photosensor 153 into a digital image signal and transferred to the CPU 120 for performing the calculation, compensation, and modification operations to the image signal. The photosensor 153 is a charge coupled device (CCD) or a complementary metal-oxide semiconductor (CMOS).

The sound source input/output unit 160 is connected to the CPU 120, for outputting the sound signal calculated through the CPU 120, and receiving an external sound and then transferring it to the CPU 120 for being calculated. The unit for outputting a sound signal is a loudspeaker, and the unit for receiving an external sound is a microphone.

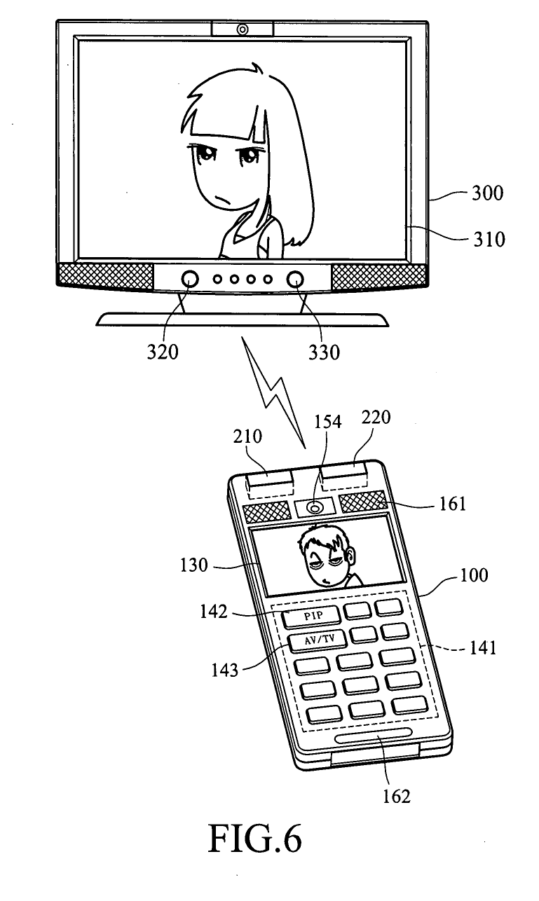

FIG. 6 is another implementation aspect of the remote control having the audio-visual function of the present invention. The user firstly presses the AV/TV switch key 143 to switch to the video function. Next, the CCD device 154 on the remote control 100 is used to capture images of the user himself/herself, and the user's spoken sounds are inputted through the microphone 162. Then, the digital audio-visual signal is calculated by the CPU, and then transferred to the wireless signal processing unit 110 for being encoded and modulated into an analog audio-visual signal. Then, the analog audio-visual signal is transferred through the RF module 220 to the RF receiver 330 of the remote TV set 300, and then demodulated into a digital audio-visual signal and decoded, such that the opposite party can view the user's images and hear the sounds from the remote TV set 300 instantly. On the contrary, the user also can receive the image and sound signal of the opposite part sent by the remote TV set 300 through the RF module 220 on the remote control 100, particularly, after an analog/digital signal conversion and decoding operation has been performed through the wireless signal processing unit 110, the digital audio-visual signal is transferred to the CPU 120 for being calculated, and thus, the images of the opposite party are displayed on the displayed picture 131, and the sounds of the opposite party are outputted by the loudspeaker 161. Therefore, the remote control of the present invention can meet the users' video conversation requirement.

Moreover, in an embodiment, the remote control having the audio-visual function of the present invention can be further used as an assistant device for finding the remote control. When the user wants to find a remote control, the remote TV set is operated to send out an RF signal, the RF signal is then received by the RF module 220 on the remote control, and meanwhile, the image-capturing unit 150 is induced to be actuated to capture the surrounding external images. Then, the external images are sent to the remote TV set through the RF module 220, such that the user can utilize the external images displayed on the remote TV set to determine the position of the remote control.

Moreover, in another embodiment, the remote control having the audio-visual function of the present invention can execute the viewing function of the digital TV, so as to serve as a portable multimedia player.

The remote control having an audio-visual function of the present invention not only has a function of a common remote control for controlling the remote TV set, but also has the characteristics of a remote control as being light in weight and small in size, which is convenient for the user to take along, and can be served as a portable mobile TV, and thus avoiding the problem of missing some excellent shots due to unexpected reasons. Moreover, the user can utilize the remote control of the present invention to view two different TV programs at the same time, so as to add the diversity and selectivity for the programs viewed by the user, and thus solving the problem in the prior art that only one program can be viewed at a time. Moreover, through the wireless transmission technique, not only the remote video conversation is achieved, but also the restrictions on the wired transmission in the prior art are no longer existed, so as to meet the requirements of the user on the mobile electronic device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote control having an audio-visual function, applicable for performing a wireless transmission of an audio-visual signal with a television (TV), comprising:
a wireless signal processing unit, for receiving the audio-visual signal and encoding/decoding and demodulating/modulating the audio-visual signal;
a central processing unit (CPU), connected to the wireless signal processing unit, for calculating the audio-visual signal;
a display unit, connected to the CPU, for displaying pictures of an image signal; and
an input interface unit, connected to the wireless signal processing unit and the display unit, for inputting a control signal to control the TV.

2. The remote control having the audio-visual function as claimed in claim 1, wherein the wireless signal processing unit comprises an infrared module having an infrared transmitter and a first signal processor, and the infrared transmitter is connected to the first signal processor, for sending the control signal to control the TV.

3. The remote control having the audio-visual function as claimed in claim 1, wherein the wireless signal processing unit comprises a radio-frequency (RF) module for executing a wireless transmission of the audio-visual signal, the RF module comprises:
an RF transmitter, for transmitting the audio-visual signal in an RF way;
an RF receiver, for receiving the audio-visual signal in an RF way;
a second signal processor, connected to the RF transmitter and the RF receiver, for demodulating/modulating the audio-visual signal; and
an encoder/decoder, connected to the second signal processor, for encoding/decoding the audio-visual signal.

4. The remote control having the audio-visual function as claimed in claim 1, further comprising:
an image-capturing unit, connected to the CPU, for capturing an external image signal; and
a sound source input/output unit, connected to the CPU, for receiving an external sound and/or outputting a sound signal.

5. The remote control having the audio-visual function as claimed in claim 1, wherein the input interface unit is a key module or a touch panel.

6. The remote control having the audio-visual function as claimed in claim 5, wherein the input interface unit has a switch for selecting to control the display unit or the remote TV.

7. The remote control having the audio-visual function as claimed in claim 4, wherein the image-capturing unit further comprises:
a lens, for capturing an external image; and
a photosensor, for converting the external image into an image signal.

8. The remote control having the audio-visual function as claimed in claim 7, wherein the photosensor is a charge coupled device (CCD) or a complementary metal-oxide semiconductor (CMOS).

9. The remote control having the audio-visual function as claimed in claim 4, wherein the sound source input/output unit comprises:
a loudspeaker, for outputting the sound signal calculated by the CPU; and
a microphone, for receiving the external sound and converting the external sound into the sound signal and transferring the sound signal to the CPU.

10. The remote control having the audio-visual function as claimed in claim 1, wherein the display unit is a liquid crystal display (LCD) or an organic light emitting diode (OLED).

11. The remote control having the audio-visual function as claimed in claim 1, wherein the remote control receives a digital signal.
